(19) United States
(12) Patent Application Publication
(10) Pub. No.: US 2013/0135874 A1
(43) Pub. Date: May 30, 2013

(54) Lamp Housing

(71) Applicants: Thomas Hofmann, Tacherting (DE); Franz Weinbrenner, Stein a.d.. Traun (DE); Peter Oberhofer, Altenmarkt (DE); Stefan Metzenroth, Marquartstein (DE); Michael Haertl, Traunstein (DE); Katrin Schroll, Matzing (DE); Peter Prodell, Trostberg (DE)

(72) Inventors: Thomas Hofmann, Tacherting (DE); Franz Weinbrenner, Stein a.d.. Traun (DE); Peter Oberhofer, Altenmarkt (DE); Stefan Metzenroth, Marquartstein (DE); Michael Haertl, Traunstein (DE); Katrin Schroll, Matzing (DE); Peter Prodell, Trostberg (DE)

(73) Assignee: SITECO BELEUCHTUNGSTECHNIK GMBH, Traunreut (DE)

(21) Appl. No.: 13/639,777

(22) PCT Filed: Apr. 4, 2011
(86) PCT No.: PCT/EP2011/001673

§ 371 Date: Dec. 12, 2012

(30) Foreign Application Priority Data
Apr. 7, 2010 (DE) 10 2010 014 067.8
Aug. 20, 2010 (DE) 10 2010 034 996.8

(51) Int. Cl. F21V 29/00

(52) U.S. Cl. CPC F21V 29/004
USPC 362/294; 362/373

(57) ABSTRACT

A luminaire housing (100, 200, 300, 400, 500) having an upper region and a lower region and a channel (110, 210, 310, 410, 415, 510), wherein the channel (110, 210, 310, 410, 415, 510) is connected to an air-exit opening (120, 220, 225, 320, 325, 420, 425) in the upper region and is connected to an air-entry opening (130, 230, 330, 430, 435, 530) in the lower region, and wherein the luminaire housing (100, 200, 300, 400, 500) also comprises an accommodating space for a lighting module (250, 550), which is arranged so that the lighting module (250, 550), in the installed state, is located on the channel (110, 210, 310, 410, 415, 510).

The invention relates to a luminaire housing and to a luminaire, in particular for streetlighting purposes, and for interior and exterior floodlighting purposes.

Lamps used in luminaires, for example LEDs, generate a considerable quantity of heat which has to be channeled away from the luminaires.

It is an object of the present invention to provide for effective cooling of a lamp, for example one or more LEDs or LED arrays of a luminaire.

The object is achieved by a luminaire housing as claimed in claim 1. The luminaire housing here, in the assembled state, has an upper region and a lower region. In the lower region, the luminaire housing has an air-entry opening, whereas it has an air-exit opening in the upper region. The air-entry opening and the air-exit opening are connected to one another by a channel. The luminaire housing also has an accommodating space for a lighting module. The accommodating space is arranged such that the lighting module, in the accommodated state, is arranged in the vicinity of the channel. In particular it is possible, in a number of embodiments, for the accommodating space to be arranged such that a side wall of the lighting module, in the accommodated state, forms a wall of the channel.

The heat produced in the lighting module, in particular in a lamp of the lighting module, is dissipated to the air located in the channel. The arrangement of the lighting module and channel adjacent to one another here gives rise to good heat transfer. This results in heating of the air in the channel. The heated air rises in the direction of the upper region of the luminaire housing. There, it leaves the luminaire housing through the air-exit opening. Relatively cool ambient air flows into the channel through the air-entry opening, which is arranged in the lower region. This gives rise to a chimney effect, which allows effective cooling of the lighting module and, in particular, of the lamp.

It is advantageous, in particular, if the channel has a regular cross section and does not comprise any side cavities in which turbulence, which would reduce the chimney effect, could be produced.

In a preferred embodiment, the luminaire housing may have an upper panel in the upper region. The air-exit opening here may be provided in the upper panel. In a particularly preferred embodiment here, the upper panel runs horizontally. This results in the heated air exiting upwards in an unobstructed manner.

In a preferred embodiment, the channel is oriented, at least in part, such that, in the assembled state of the luminaire housing, it runs parallel to gravitational force. This enhances the chimney effect.

In a preferred embodiment, the luminaire housing has a side wall and the air-exit opening is arranged in the upper region of the side wall. The air-exit opening is thus arranged laterally on the housing. In this embodiment, objects which fall downward, such as raindrops or dirt, are therefore less able to penetrate into the channel and settle there.

In a preferred embodiment, the luminaire housing has an underside and the air-entry opening is arranged on the underside. Arrangement on the underside results in a maximum channel length, and therefore the chimney effect is enhanced.

In other embodiments, the air-entry opening is arranged in the lower region of a side wall. This means that the air-entry opening is not visible from beneath to an observer.

In a preferred embodiment, the luminaire housing also has one or more cooling ribs in the upper region. In a particularly preferred embodiment, these are arranged on an upper panel. The upper panel here terminates the luminaire housing in the upward direction. The cooling ribs are preferably directed upward away from the panel. The cooling ribs increase the effective surface area along which heat is dissipated from the luminaire housing to the surrounding air.

The cooling ribs may be produced, for example, from a metal which is a good heat conductor and may comprise, in particular, aluminum and/or copper.

In a particularly preferred embodiment, the luminaire housing here has a group of a plurality of cooling ribs, of varying heights within the group. In particular it is possible for the height of the ribs to be highest in the region of the center of the group and to decrease in the direction of the peripheries. The ribs are preferably highest in the center above the accommodating space. Since a lamp is usually arranged in the center of the lighting module, this is where the most heat is often produced. This is therefore the location at which the height of the ribs and thus the effective surface area over which heat is dissipated to the surrounding air are selected to be at their greatest. It is usually the case that less heat is produced in the direction of the peripheries, and therefore, in the direction of the peripheries of the lighting module, the ribs may be shorter and it is thus possible to cut back on material for the cooling ribs.

In a preferred embodiment, the accommodating space for the lighting module, furthermore, is arranged in the upper region of the luminaire housing. In particular it is possible for the luminaire housing to have an upper panel with the accommodating element arranged on the underside thereof. This allows the heat produced in the lighting module to be transferred effectively to the air surrounding the luminaire housing. This effect can be further enhanced, as described above, by cooling ribs on the opposite side of the upper panel.

In a preferred embodiment, the housing has a plurality of air-exit openings in the upper region and/or a plurality of air-entry openings in the lower region. The air-exit openings and air-entry openings here may be connected to one another by one or more channels. In particular it is possible for one channel to be connected to a plurality of air-entry openings and/or a plurality of air-exit openings. In other embodiments, the luminaire housing has a plurality of air-entry openings and a plurality of air-exit openings, wherein in each case one air-entry opening is connected to an air-exit opening via one channel. The channels here are arranged such that the lighting module, in the installed state, is arranged in the vicinity of the channels. This gives rise to good thermal coupling between the lighting module and the air flowing through the channels.

According to a preferred embodiment, the luminaire housing has a plurality of channels which are connected jointly to an air-entry opening and/or an air-exit opening. In this case, fewer openings are necessary in order to supply a relatively large number of channels.

In embodiments in which two or more channels are assigned one air-exit opening and/or one air-entry opening, the channels can come together in a Y shape in the region in front of the opening.

In a preferred embodiment, at least two channels are adjacent to one accommodating space. This can achieve a better cooling action for the accommodating space.

As an alternative, or in addition, the luminaire housing may have two accommodating spaces for lighting modules, which are adjacent to one channel. This makes it possible for a plurality of lighting modules to be cooled by means of one channel, with only a small amount of volume being required.

In a preferred embodiment, the air-entry opening and/or the air-exit opening are/is in the form of a slot. In a number of particularly preferred embodiments, as an alternative, or in addition, the channel is designed as a slot. This results in a particularly advantageous ratio between the channel surface area provided for cooling purposes and channel volumes. As a result, the greatest possible cooling action is achieved while volume requirements are kept to a minimum.

In a preferred embodiment, the upper panel, furthermore, is angled upward in the region of the air-exit opening. In a particularly preferred embodiment, the angled region of the upper panel has a plurality of air-exit openings. This allows the air-exit openings to be arranged further upward, as a result of which there is an increase in length of the channel between air-entry opening and air-exit opening. This enhances the chimney effect, as a result of which the cooling action is improved. As an alternative, or in addition, a shroud, at which the air-exit opening opens out, may be provided on the upper panel, as a separate component or in a single piece. This results in the opening being covered in the upward direction, and therefore it is not possible for any dirt or water to penetrate into the channel.

According to a preferred embodiment, the luminaire housing has an upper panel which is adjacent to the air-entry opening and is angled into the lower region of the luminaire housing in the region of the air-entry opening.

The upper panel may be designed, in particular, in a single piece or comprise a plurality of lamellae. Furthermore, the air-entry opening may be arranged between two lighting-module accommodating spaces provided in the luminaire housing. It is also possible for the upper panel to be angled a number of times and to run in planar fashion between the angled portions. Furthermore, the upper panel may have a right angle. In other embodiments, the upper panel is curved downward.

The angled form of the upper panel gives rise to an increased surface area, as a result of which it is easier for heat to be dissipated to the surrounding air. This results in a better cooling action. In particular it is possible for the upper panel, in this embodiment, to be adjacent to the channel over the entire length of the latter. This allows effective heat transfer between the flowing air and the channel and the upper panel.

In a preferred embodiment, the luminaire housing also has at least two cooling ribs which are arranged, at least in part, in the channel and, in addition, run through the air-exit opening. The cooling ribs may run, in particular, parallel to one another. It is also possible for two adjacent cooling ribs to be spaced apart from one another, in particular by between 25 mm and 100 mm, preferably by between 30 mm and 70 mm, particularly preferably by between 35 mm and 50 mm.

This embodiment has the advantage that flow takes place particularly advantageously around the surface of the cooling ribs, as a result of which the cooling effect is further enhanced. Furthermore, this improved cooling effect is achieved with only a small amount of material being used. In the air-exit opening, furthermore, at least one partial opening is defined by the cooling ribs running through it. The envisaged dimensions for the spacing between the cooling ribs here prevents, in particular, the situation where the air-exit opening becomes clogged by dirt, in particular by foliage, as the partial opening defined in this way is too small for falling leaves.

In other embodiments, it is possible for the cooling ribs to be inclined in relation to one another or to intersect one another. In particular, the cooling ribs may define a lattice-like structure in the air-exit opening. The partial opening may then, in particular, be in the form of a slot or of a polygon. In other embodiments, the cooling ribs may be curved. In particular it is possible for the cooling ribs to define partial openings with curved borders in the air-exit opening.

In an independent aspect, the object is achieved by a luminaire as claimed in claim 16 of the invention, also comprising a lighting module.

In a particularly preferred embodiment, a side wall of the lighting module here forms a wall of the channel. This gives rise to a shorter heat-flow path from the lighting module to the air in the channel, and therefore better heat dissipation is established.

The side wall of the lighting module, which forms a wall of the channel, may also have cooling ribs on the side which is directed toward the channel, in order to increase the effective surface area over which heat is transported. The ribs here may run, in particular, in the longitudinal direction of the channel, and it is therefore possible for the air to flow in the channel between the ribs from the air-entry opening to the air-exit opening.

The cooling ribs may be produced, for example, from a metal which is a good heat conductor and may comprise, in particular, aluminum and/or copper. The cooling ribs may also be formed, in particular, in a single piece with the side wall.

The lighting module here, furthermore, may comprise one or more lamps, in particular one or more LEDs or LED arrays.

Further advantages and design details of the present invention will become clear with reference to the following description of preferred embodiments in conjunction with the accompanying drawings, in which:

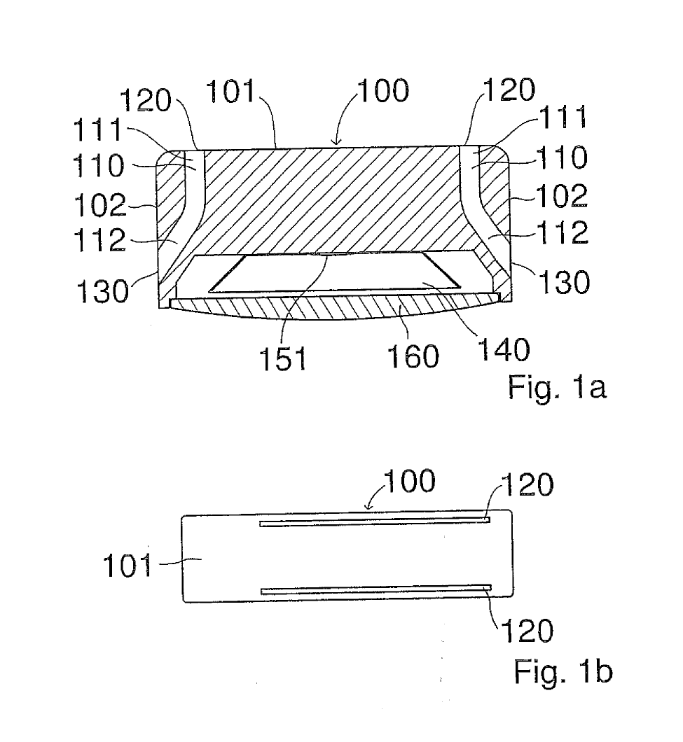

FIG. 1a shows a cross section through a first embodiment of a luminaire according to the invention having a luminaire housing,

FIG. 1b shows a plan view of the luminaire housing according to FIG. 1a,

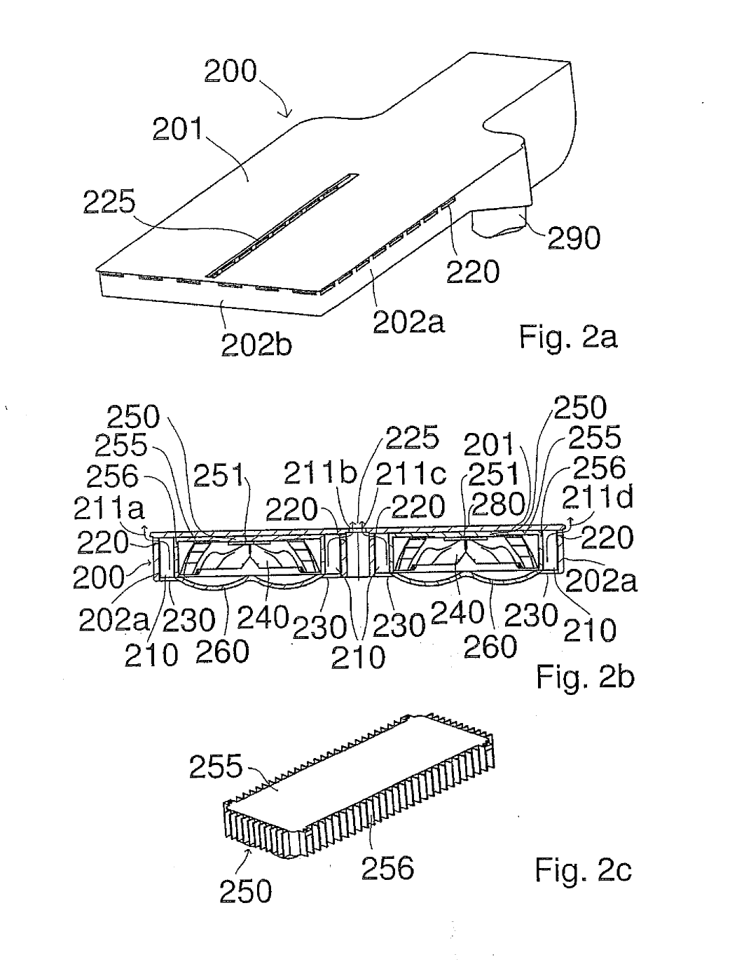

FIG. 2a shows a perspective view of a second embodiment of a luminaire according to the invention having a luminaire housing,

FIG. 2b shows a cross section through the luminaire according to FIG. 2a,

FIG. 2c shows a perspective view of a lighting module of the luminaire according to FIG. 2a,

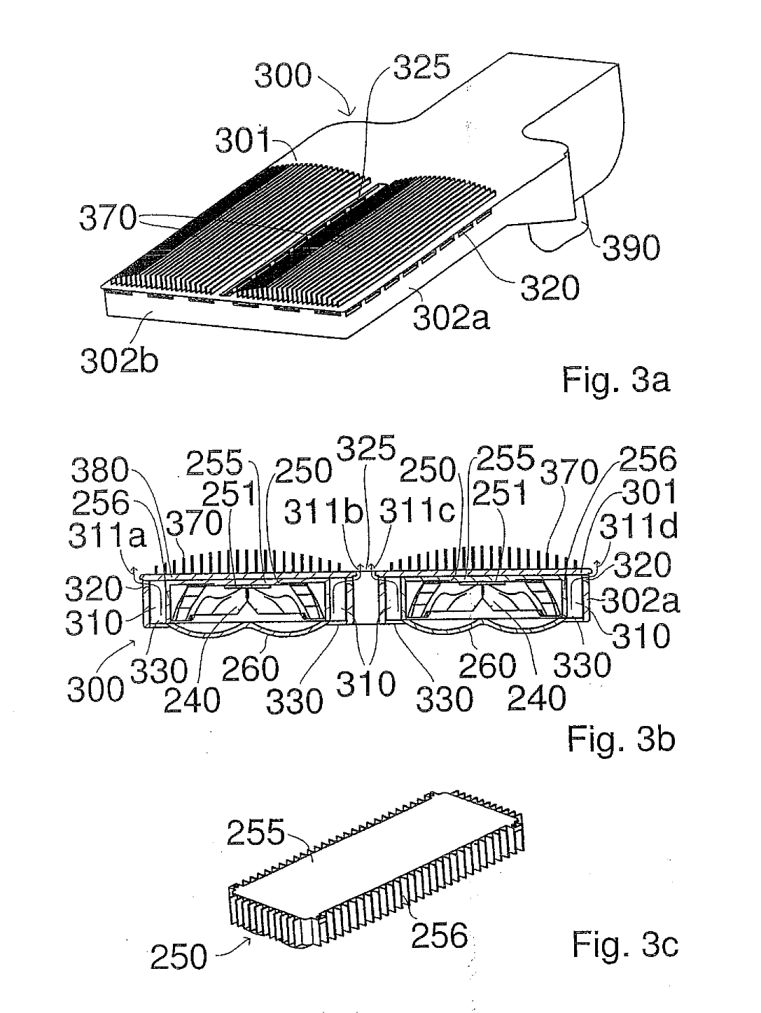

FIG. 3a shows a perspective view of a third embodiment of a luminaire according to the invention having a luminaire housing,

FIG. 3b shows a cross section through the luminaire according to FIG. 3a,

FIG. 3c shows a perspective view of a lighting module of the luminaire according to FIG. 3a,

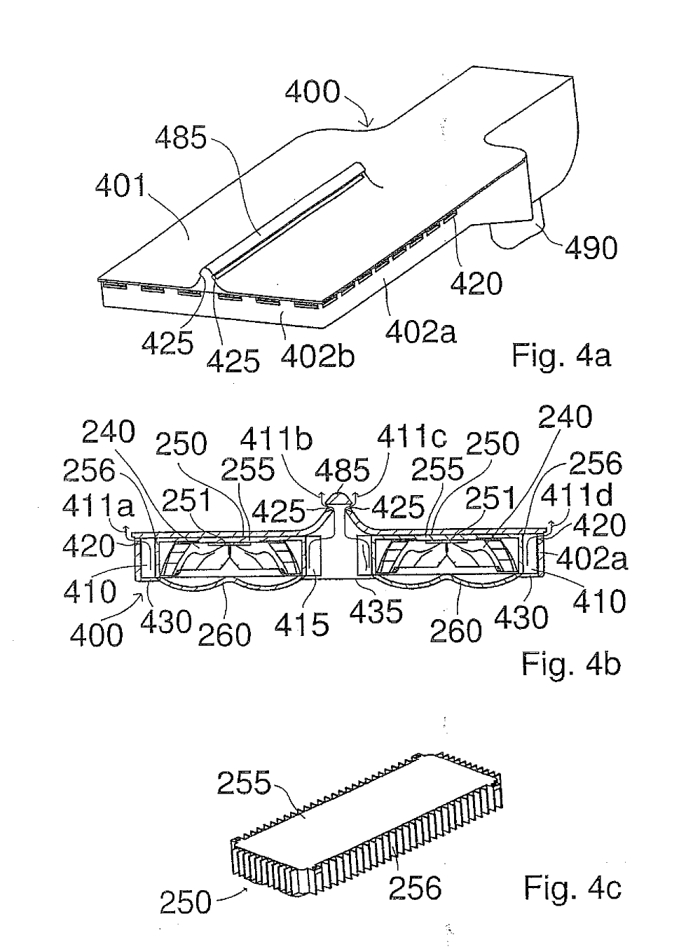

FIG. 4a shows a perspective view of a fourth embodiment of a luminaire according to the invention having a luminaire housing,

FIG. 4b shows a cross section through the luminaire according to FIG. 4a,

FIG. 4c shows a perspective view of a lighting module of the luminaire according to FIG. 4a,

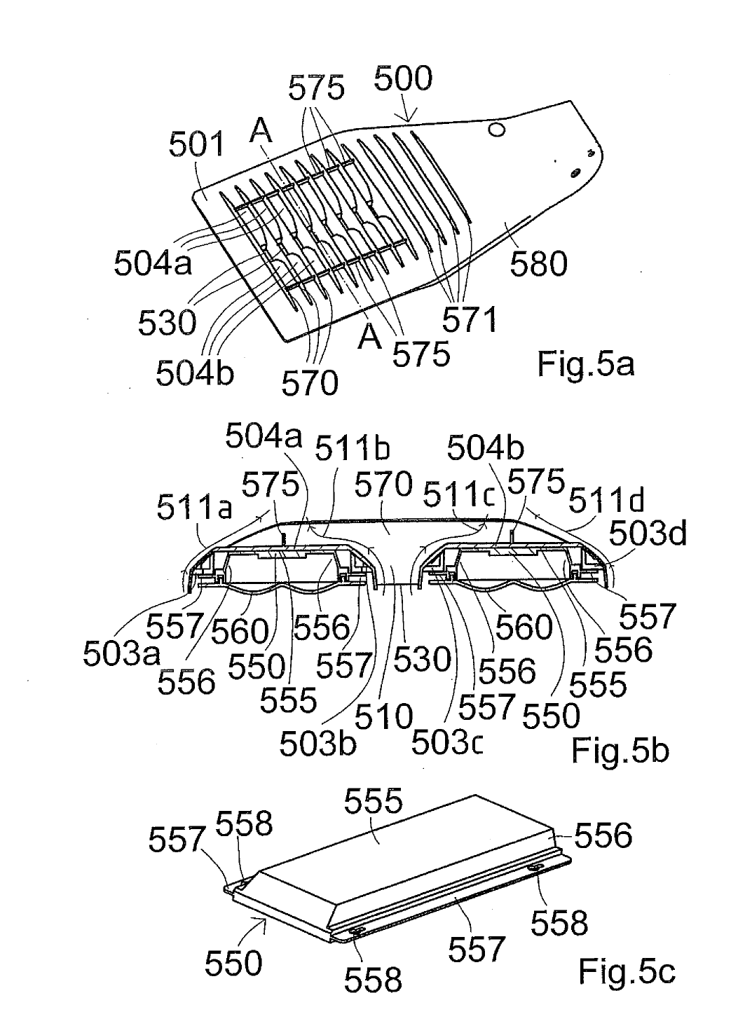

FIG. 5a shows a perspective plan view of a fifth embodiment of a luminaire according to the invention having a luminaire housing,

FIG. 5b shows a cross section through the luminaire according to FIG. 5a taken along line A-A, and

FIG. 5c shows a perspective view of a lighting module of the luminaire according to FIG. 5a.

A first embodiment of a luminaire housing according to the invention and of a luminaire according to the invention is illustrated in FIGS. 1a and 1b. The luminaire housing 100 here has two channels 110. The channels 110 each extend between an air-entry opening 130 and an air-exit opening 120. The air-entry openings are arranged in side walls 102 of the luminaire housing 100. The air-exit openings 120 are located on the upper side 101 of the luminaire housing 100. The air-exit openings 120 here are of slot-like design, as can be seen in FIG. 1b. The channels 110 each have two portions. An upper portion 111 of the channel 110, this portion being adjacent to the air-exit opening 120, runs rectilinearly and essentially perpendicularly to the upper side 101. A lower portion 112 of the channel 110 is angled in relation to the upper portion 111 and extends from the upper portion 111 to the air-entry opening 130. The air-exit opening 120 here is somewhat narrower than the air-entry opening 130. A reflector 140 is also arranged in the luminaire housing 100. In the assembled state, a lamp 151 is located within the reflector. Also, a covering 160 is fitted on the underside of the luminaire housing 100, the light emitted from the lamp 151 leaving the luminaire housing 100 through this covering.

A second embodiment of the luminaire housing according to the invention and of the luminaire according to the invention is illustrated in FIGS. 2a to 2c. The luminaire housing 200 here has a plurality of air-exit openings 220 on its side walls 202a and on its end side 202b. The air-exit openings 220 here are each arranged in the upper region of the walls 202a, 202b. A plurality of air-entry openings 230 are located on the underside of the luminaire housing. The air-exit openings 220, which are located on the walls, are connected to the air-entry openings 230 via channels 210. The arrows 211a to d here represent the flow of the air from the air-entry opening to the air-exit opening. Lighting modules 250 having a light source 251 and a reflector arrangement 240 are also located in the luminaire housing 200. The light generated by the light source 251 leaves the luminaire housing 200 through the covering 260. The heat produced in the lighting module 250 is dissipated via a side wall 256 of the module 250. This side wall forms a wall of the channel 210 at the same time, and therefore the heat is passed on effectively to the air located in the channel 210.

In addition, the luminaire housing 200 contains, in the center, two further channels 210, each connected to an air-entry opening 230 on the underside of the luminaire housing. The two central channels 210 each terminate here at opening 220 arranged vertically. The heated air leaves the luminaire housing 200 through a central opening 225 arranged on the upper side. This embodiment has the advantage that use can be made of two identical lighting modules 250. Each of the channels 210 is formed on one side by a wall of the luminaire housing and on the opposite side by a side wall 256 of the lighting module 250. The lighting modules 250 here have their upper side 255 fastened on the upper panel 280 of the luminaire housing 200.

The luminaire housing 200 also comprises a fastening device 290, in order to fasten the luminaire housing 200, for example, on a lamppost.

FIG. 2c shows a view of the lighting module 250 in which the upper side 255 and the side wall 256 can be seen. The side wall 256 of the lighting module here forms a wall of a channel 210 of the luminaire. In this embodiment, the side wall 256 is also provided with cooling ribs, and therefore the surface area over which heat is dissipated to the air located in the channel 210 is increased.

FIGS. 3a to 3c show a third embodiment of the luminaire housing according to the invention and of the luminaire according to the invention. This embodiment differs from the second embodiment by groups 370 of parallel cooling ribs arranged, in addition, on the upper side 301 of the housing 300. The ribs here extend vertically upward from the surface 301. The length of the ribs varies. The ribs are longest in the center above the lighting module 250, whereas the length of the ribs decreases in the direction of the sides. The group 370 of cooling ribs here extends both over the region of the accommodating space for the lighting module 250 and over the channel 210. The cooling ribs give rise to an additional cooling effect, which is at its most pronounced in the region of the lighting module 250 in which the heat is produced.

FIGS. 4a to 4c show a fourth embodiment of the luminaire housing according to the invention and of the luminaire according to the invention. The luminaire housing 400 here has an upper panel 480 which is curved upward in the region of a central air-exit opening. The opening is covered by a shroud 485, air-exit openings 425 being arranged at the periphery of the opening, between the shroud 485 and the upper panel 480. The shroud 485 prevents foreign bodies from penetrating into the channel 415 located beneath the openings 425. The channel 415 here is connected to the air-entry opening 435. In other embodiments, it is possible to provide additional side walls on the luminaire housing which reduce the channel width in the region of the curvature. This makes it possible to establish a desired channel width.

FIGS. 5a to 5c show a further embodiment of the luminaire housing according to the invention and of the luminaire according to the invention, having two lighting modules 550. The luminaire housing 500 also has an elongate channel 510 and an elongate air-entry opening 530, which are arranged in a central region of the luminaire housing 500, between the accommodating spaces for the lighting modules 550. The accommodating spaces here are likewise of elongate configuration. The channel 510 and the air-entry opening 530 run parallel to the longitudinal direction of the accommodating spaces for the lighting modules 550. The air-entry opening 530 is bounded on its longitudinal sides by an upper panel 580, which is angled downward in the region of the centrally arranged air-entry opening 530. In two regions adjoining the longitudinal sides of the air-entry opening 530, the upper panel 580 runs over the accommodating spaces for the lighting modules 550. The upper panel 580 also has keel elements 575, which run parallel to the channel 510. The keel elements 575 are also each arranged in the center above the accommodating spaces for the lighting modules 550. Furthermore, the luminaire housing 500 has a plurality of parallel cooling ribs 570, which run perpendicularly to the channel 510. The cooling ribs 570 are thus likewise perpendicular to the elongate lighting modules 550 accommodated. The cooling ribs 570 also run through the channel 510. In particular, the cooling ribs begin at the air-entry opening 530. From there, they run upward. In each case two adjacent cooling ribs 570 are spaced apart equally from one another. The channel 510 terminates, in the region of the keel elements 575, in an air-exit opening. The cooling ribs 570 are arranged such that the air-exit opening is subdivided into partial openings in the form of uniform strips. In particular the strip-like partial openings defined in this way are of the same width.

During operation of the luminaire illustrated, the heat generated gives rise to an air stream which is illustrated with reference to the flow arrows 511abcd in FIG. 5b. Whereas the flow arrows 511ad run laterally along the luminaire housing 500, the flow arrows 500bc indicate the flow through the channel 510. The air flows, through the air-entry opening 530, into the centrally arranged channel 510 and flows through between the accommodating spaces. In the region of the keel elements 575, the air stream then widens.

FIG. 5c illustrates a lighting module 550, as is also shown in the luminaire in FIG. 5b. The lighting module 550 is of elongate form with an upper side 555 and side walls 556. The side walls 556 are angled in relation to the upper side 555. The angle here is less than 90°. Furthermore, in its lower region, the lighting module 550 has two flanges 557. The flanges 557 run parallel to the upper side 555 of the lighting module 550. Two bores 558 are also provided in each of the flanges 557. The bores 558 serve for fastening the lighting module 550 on a luminaire housing with the aid of screws. The bores 558 also have lateral convexities, in order to compensate for production tolerances during the production of the lighting module 550 or of the luminaire housing. The upper side 555 runs in planar fashion.

The luminaire housing 500 has two accommodating spaces for the purpose of accommodating the lighting modules 550. Each accommodating space here comprises two carrier elements 503abcd. In the cross section shown in FIG. 5b, the carrier elements 503abcd are in the form of a tilted L. The carrier elements 503abcd here each have an upper limb, which is essentially parallel to the course taken by the channel 510, and a lower limb, which is parallel to the air-entry opening 530. For assembly purposes, the lighting module 550 is screwed to the lower limbs for the carrier elements 503abcd by means of the bores 558 in the flanges 557. Furthermore, each accommodating space has a heat-transfer region 504ab, which runs essentially parallel to the air-entry opening 530, for a lighting module 550. The heat-transfer regions 504ab here run in planar fashion. In the assembled state, the upper side 555 of the lighting module 550 butts in planar fashion against the heat-transfer region 504ab. The resulting relatively large contact surface area between the upper side 555 of the luminaire housing 550 and the heat-transfer region 504ab gives rise to efficient heat transfer between the lighting module 550 and the heat-transfer region 504ab, and the cooling of the lighting module 550 is thus further improved. The keel elements 575, furthermore, are arranged in the center above the heat-transfer regions 504ab.

In other embodiments, the upper side of the lighting module and the heat-transfer regions of the luminaire housing may be of non-planar form. In particular it is possible for both to have ribs. The ribs of the lighting module and the ribs of the luminaire housing here may, in particular, be configured such that they engage one inside the other. This increases the contact surface area and the heat transfer between the lighting module and the luminaire housing is further improved.

FIG. 5b likewise shows a covering 560 for each of the lighting modules 550. In the embodiment illustrated, the two accommodating spaces are of identical design, and therefore use can be made of two identical lighting modules 550.

The luminaire housing 500 also has additional cooling ribs 571. These are located on an upper side 501 of the upper panel 580 and extend perpendicularly thereto. The additional cooling ribs 571 are arranged parallel to the cooling ribs 570. The additional cooling ribs 571 are located outside the channel 510. The additional cooling ribs 571 further improve the cooling of the luminaire housing 500.

In this embodiment, in particular the upper panel 580, the keel elements 575 and also the cooling ribs 570 and the additional cooling ribs 571 are formed in a single piece. In other embodiments, it is possible in particular for the cooling ribs 570 and/or the additional cooling ribs 571 to be in the form of separate components. In further embodiments, the heat-transfer regions 504ab may be designed as separate structural elements. The keel elements 575 here may be in one piece with the lamellae.

### LIST OF DESIGNATIONS

100, 200, 300, 400, 500 luminaire housing

101, 201, 301, 401, 501 upper side

102, 202a, 302a, 402a side wall

202b, 302b, 402b end wall

110, 210, 310, 410, 415, 510 channel

111 upper channel portion

112 lower channel portion

120, 220, 225, 320, 325, 420, air-exit opening

425

130, 230, 330, 430, 435, 530 air-entry opening

140, 240 reflector

151, 251 lamp

160, 260, 560 covering

211abcd, 311abcd, 411abcd, air-flow arrows

511abcd

250, 550 lighting module

255, 555 upper side

256, 556 side wall

280, 380, 480, 580 upper panel

290, 390, 490 fastening device

370 group of cooling ribs

485 shroud

557 flange

558 bore

503abcd carrier element

504ab heat-transfer region

570, 571 cooling ribs

575 keel element

1. A luminaire housing having an upper region and a lower region and a channel wherein the channel is connected to an air-exit opening in the upper region and is connected to an air-entry opening in the lower region, and wherein the luminaire housing also comprises an accommodating space for a lighting module, which is arranged so that the lighting module, in the installed state, is located on the channel.

2. The luminaire housing as claimed in claim 1, having an upper panel, wherein the air-exit opening is located in the upper panel.

3. The luminaire housing as claimed in claim 1, wherein the channel is oriented such that, in the assembled state of the luminaire housing, it runs, at least in part, parallel to the direction of the action of gravitational force.

4. The luminaire housing as claimed in claim 1, having a side wall, wherein the air-exit opening is located in the upper region of the side wall.

5. The luminaire housing as claimed in claim 1, wherein the air-entry opening is located on an underside and/or in a side wall of the luminaire housing.

6. The luminaire housing as claimed in claim 1, having an upper panel, wherein a group of cooling ribs is located on one side of the upper panel, and the accommodating space for the lighting module is arranged on the opposite side of the upper panel, opposite the group.

7. The luminaire housing as claimed in claim 6, wherein the length of the cooling ribs varies within the group, in particular decreases from the center of the group in the direction of the periphery.

8. The luminaire housing as claimed in claim 1, having at least two channels which are connected to a common air-exit opening and/or a common air-entry opening.

9. The luminaire housing as claimed in claim 1, having a plurality of accommodating spaces for lighting modules, wherein one channel is adjacent to at least two accommodating spaces.

10. The luminaire housing as claimed in claim 1, having a plurality of channels, wherein one accommodating space is adjacent to at least two channels.

11. The luminaire housing as claimed in claim 1, wherein the air-entry opening and/or the air-exit opening are/is designed as a slot.

12. The luminaire housing as claimed in claim 1, having an upper panel, wherein the air-exit opening is arranged in the panel and the panel is curved upward in the region of the air-exit opening.

13. The luminaire housing as claimed in claim 1, having an upper panel, wherein a channel-extending element is arranged on the upper panel, in the region of the air-exit opening, and extends the length of the channel upwards beyond the upper panel.

14. The luminaire housing as claimed in claim 1, having an upper panel, wherein the upper panel is adjacent to the air-entry opening and is angled into the lower region of the luminaire housing in the region of the air-entry opening.

15. The luminaire housing as claimed in claim 1, also having at least two cooling ribs which are arranged, at least in part, in the channel and run through the air-exit opening, wherein the cooling ribs are, in particular, parallel, and wherein two adjacent cooling ribs are spaced apart from one another, in particular by between 25 mm and 100 mm, preferably by between 30 mm and 70 mm, and particularly preferably by between 35 mm and 50 mm.

16. A luminaire having a luminaire housing as claimed in claim 1, and also comprising a lighting module, wherein the lighting module has a side wall and an upper side, wherein the side wall and/or the upper side of the lighting module are/is adjacent to the channel.

17. The luminaire as claimed in claim 16, in the case of which the side wall forms a wall of the channel.

18. The luminaire as claimed in claim 16, wherein the side wall has cooling ribs which are directed into the channel.

19. The luminaire as claimed in claim 18, wherein the cooling ribs run, at least in part, parallel to the channel.

20. The luminaire as claimed in claim 16, wherein the upper side of the lighting module is arranged on an upper panel of the luminaire housing.

21. The luminaire as claimed in claim 16, wherein the lighting module also comprises a reflector and a lamp.
